(19) United States
(12) Patent Application Publication
(10) Pub. No.: US 2008/0058466 A1
(43) Pub. Date: Mar. 6, 2008

(54) Polymeric Plasticizers for Polymer Compositions Exhibiting High Surface Energy

(76) Inventors: Makarand V. Joshi, Grayslake, IL (US); William D. Arendt, Libertyville, IL (US); Kimberly Rausch, Elk Grove Village, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/469,959

(22) Filed: Sep. 5, 2006

(51) Int. Cl. C08F 214/06

(52) U.S. Cl. 524/567

(57) ABSTRACT

Shaped articles, including but not limited to films, moldings and extruded profiles exhibiting a unique combination of desirable properties including high surface energy, permanence of the plasticizer, and processability are prepared from polymer compositions comprising a rigid organic polymer and a unique class of polyesters as plasticizers. The shaped articles are printable using both organic solvent- and water-based inks.

### BACKGROUND OF THE INVENTION

1. Field of the Invention

This invention relates to polymeric plasticizers capable of imparting unique combinations of useful properties to polymer compositions. More particularly, this invention relates to polyesters containing non-reactive terminal units that improve the processability of polymer compositions into which they are incorporated relative to prior art plasticizers. These polymer compositions are particularly useful for the production of calandered films exhibiting sufficiently high values of surface energy to allow printing using either organic solvent- or water-based inks.

2. Background

Polyester type plasticizers have been used in a variety of polymer compositions. Plasticizers of this type are described in detail in chapter 6 of the Handbook of PVC Formulating edited by Edward J. Wickson, pp. 223-252, published by John Wiley and Sons (1993).

Polyesters suitable as plasticizers are prepared by reacting an aliphatic or aromatic dicarboxylic acid with a diol, glycol or oligomeric glycol. The average molecular weight of a polymer is dependent upon a number of variables, including but not limited to the polymerization catalyst used, the molar ratio of the monomers, the concentration of any monofunctional alcohols or carboxylic acids, and the conditions of the polymerization reaction.

When it is desired to have a non-reactive group at the ends of the polymer molecules a monofunctional alcohol and/or monocarboxylic acid is either present in the initial reaction mixture or is added during the polymerization reaction.

Polyesters used as plasticizers typically have weight average molecular weights of from about 1,000 up to 13,000 or higher. In the absence of monofunctional reactants a majority of the terminal units on the polymer molecules will be hydroxyl or carboxyl, depending upon the stoichiometry of the monomers.

A polymer composition typically contains a number of additional additives other than the plasticizer to facilitate subsequent processing of the composition and/or impart desired properties the shaped article or film formed from the polymer composition. The types and amounts of additives will depend upon the equipment and conditions used to process the polymer and the desired physical properties of the final article, and include but are not limited to lubricants, polymeric processing aids, anti-oxidants, heat stabilizers, flame retardants, fillers and pigments.

The compositions of the present invention include 1) plastisols containing only a rigid polymer, one of the present plasticizers and up to 5 weight percent, based on plastisol weight, of an organic liquid that is miscible with said plasticizer but which is not a solvent for said polymer, and 2) organosols consisting essentially of the aforementioned polymer, plasticizer and typically 5 to 70 weight percent of said organic liquid.

One objective of the present invention is to provide a class of polymeric plasticizers for a variety of polymer compositions that are not only effective plasticizers but also reduce or eliminate the need for some of the additives and modifiers such as lubricants, process aids and/or heat stabilizers required in polymer compositions containing other polymeric plasticizers. The plasticized polymer compositions of this invention are particularly useful for the fabrication of films, moldings and extruded profiles that can be printed upon.

### SUMMARY

This invention provides polyester plasticizers exhibiting a weight average molecular weight of from 1,000 to 5,000 and comprising repeating units of the general formula —OR¹O(O)CR²C(O)—, wherein at least 96 percent of the terminal units of said polyester exhibit a general formula selected from the group consisting of R³C(O)— and R⁴O—, R¹ is at least one member selected from the group consisting of linear and branched alkyl radicals containing from 3 to 6 carbon atoms, R² is at least one member selected from the group consisting of alkylene containing from 1 to 10 carbon atoms and phenylene, R³ is at least one member selected from the group consisting of alkyl radicals containing from 1 to 24 carbon atoms and phenyl, R⁴ is at least one member selected from the group consisting of alkyl radicals containing from 1 to 24 carbon atoms and tolyl and wherein the hydroxyl number of said polyester is less than 10 mg. of KOH/gram

The present plasticizers can be liquids, solids or semi-solids at 25° C.

This invention also provides 1) polymer compositions exhibiting a unique and desirable combination of properties due to the presence of the present plasticizers and 2) films, and shaped articles, including but not limited to molded objects and extruded profiles, prepared from these polymer compositions.

The plasticized polymer compositions of this invention are typically finely divided solids requiring processing under shear and at elevated temperatures using an extruder, roller mill or similar equipment to yield a flowable liquid material.

The present polyesters, monomers suitable for preparing these polyesters, polymer compositions containing these polyesters, shaped articles formed from these compositions and the combination of properties that distinguish these shaped articles from articles prepared using polymer compositions containing other plasticizers will now be described in detail.

### DETAILED DESCRIPTION

### Molecular Weight

The weight average molecular weight of the present plasticizers is between 1,000 and 5,000 g./mol. The molecular weight of the polymers is controlled by including a total of from 11 to about 22 weight percent of at least one monofunctional carboxylic acid and/or at least one monofunctional alcohol as a chain terminator in the reaction mixture used to prepare the polymer. The chain terminator(s) can be added together with the difunctional reactants or during the polymerization reaction.

The advantages associated with the present molecular weight range and low hydroxyl number relative to higher or lower molecular weights and higher hydroxyl numbers is a combination of efficiency (less plasticizer required to achieve desired properties in a polymer/plasticizer blend), improved processability of this blend, higher surface energy exhibited by films and shaped articles, and the permanence of the plasticizer.

Outside of the present ranges for molecular weight and hydroxyl number at least one of the aforementioned properties is sacrificed. For example, lower molecular weight plasticizers are less permanent, resulting in a more rapid deterioration of the desirable properties imparted by the plasticizer. Higher molecular weight plasticizers may be more permanent than the present group of plasticizers; however this is achieved at a sacrifice of one or more of the other desirable properties that characterize the present group of plasticizers.

### Terminal Groups

The polymeric plasticizers of this invention contain less than about 4 weight percent of molecules with terminal hydroxyl or carboxyl groups.

Terminal hydroxyl groups have been shown to decrease the resistance of the plasticizer to migration and/or extraction in humid environments, while terminal carboxyl groups, while providing desirable lubricity, adversely affect the heat stability of the plasticizer. A combination of terminal carboxyl and hydroxyl groups provides lubricity without sacrificing surface energy. The relative concentrations of the two types of terminal groups will be determined by the properties desired in the plasticized polymer composition.

As previously stated, the hydroxyl number of the present polyesters should preferably not exceed 10 mg. of potassium hydroxide/gram.

The non-reactive terminal groups of the present plasticizers are represented by the formulae R³C(O)— and R⁴O— wherein R³ and R⁴ are as previously defined. R³ preferably contains from 12 to 18 carbon atoms and R⁴ is preferably alkyl containing from 8 to 16 carbon atoms or a phenylalkyl radical such as tolyl. Particularly preferred terminal groups are derived from palmitic acid and hexadecanol. Terminal groups derived from saturated fatty acids impart excellent lubricating properties that allow reduction or elimination of additional lubricants such as stearic acid and heat stabilizers such as barium/zinc and calcium/zinc stearates.

### The Dihydric Alcohols

Dihydric alcohols and monomeric glycols suitable for preparing the present plasticizers contain from 3 to 6 carbon atoms. Preferred dihydric alcohols include but are not limited to 1,3- and 1,4-butanediols, neopentyl glycol, 2-methyl-1,3-propanediol and 1,2-propanediol. This preference is based on the compatibility of the resultant plasticizer with a wide variety of organic polymers.

### The Dicarboxylic Acid

Dicarboxylic acids suitable for preparing the present plasticizers are represented by the formula HO(O)CR²C(O)OH wherein R² is at least one member selected from the group consisting of linear and branched alkylene radicals containing from 1 to 10 carbon atoms and phenylene. Preferably R² is linear alkylene and contains from 4 to 6 carbon atoms. Adipic acid is the most preferred dicarboxylic acid, based on the commercial availability of this acid and the properties of the resultant plasticizer.

### Preparation of Polymeric Plasticizers

The polymeric plasticizers of the present invention are prepared using known methods for preparing polyesters. Typically the difunctional and monofunctional reactants together with an esterification catalyst such as hydrated monobutyl tin oxide are combined in a suitable reactor and heated to temperatures of from about 205 to 225° C.

The water formed as a by-product of the esterification reaction is preferably removed by distillation throughout the polymerization. The progress of the polymerization can be monitored by measuring the kinematic viscosity, the hydroxyl number and/or the acid number exhibited by the reaction mixture.

When the desired viscosity, acid number and hydroxyl number have been achieved the polyester is purified. This procedure may include placing the reaction mixture under reduced pressure to remove volatile materials such as unreacted monomers and any solvents used during the polymerization reaction. Typical values for the present polyesters are a kinematic viscosity of from 75 to 80 centistokes, measured at 98.9° C., a hydroxyl number of less than 10 mg. of KOH/gram and an acid number less than 1 mg. of KOH/gram.

Additional purification procedures that can be employed include but are not limited to filtration and bleaching using hydrogen peroxide to react with high boiling colored materials in the final reaction mixture.

Depending upon their molecular weight the present plasticizers can be liquids, solids or semi-solids at 25° C.

Examples of polymers suitable for use with the plasticizers of this invention include but are not limited to homo- and copolymers of vinyl chloride, homo- and copolymers of acrylic and methacrylic acid and esters thereof, polyurethanes, epoxide polymers, and elastomers, including but not limited to neoprene and nitrile rubbers.

The plasticizer typically constitutes from 10 to 50 weight percent, preferably from 15 to 35 weight percent, of the polymer composition. The optimum concentration range will vary depending upon the intended end use application of the polymer composition. This range provides the desired softness of the polymer composition in addition to the benefits of the present class of plasticizers. As used herein, “desired softness level” refers to Shore Hardness of about 50 to about 95, preferably about 75 to about 85.

The desirable combination of properties exhibited by polymer compositions containing the present plasticizers facilitates formation of films, extruded profiles, and moldings and other shaped articles from polymer compositions and the receptivity of these articles to printed and decorative material applied using both aqueous- and organic solvent-based dyes and inks. The films exhibit improved heat stability relative to films prepared using prior art plasticizers.

The present plasticizers are particularly useful for imparting lubricity and excellent processing characteristics of polymer compositions without adversely affecting the surface energy and the receptivity of films formed from these compositions to inks.

The unique combination of properties of films formed from the plasticized polymer compositions of this invention include but are not limited to high surface energy, processability, permanence of the plasticizer, and increased humidity resistance. Some of these desirable properties are described in more detail in the following paragraphs and examples. Commercial applications of the film include but are not limited to decals, packaging, laminates, tapes for various applications, including electrical insulation, and liners for metallic and non-metallic containers of various types, including but not limited to boxes and other types of shipping containers, cans, tanks and swimming pools.

### Surface Energy

Films and other shaped articles formed from polymers containing the present plasticizers, particularly those terminated with monofunctional alcohols, exhibit higher values of surface energy than have been observed in films using structurally related plasticizers. These values are typically above 34 dynes/cm in an important aspect, about 37 to about 40 dynes/cm. High levels of surface energy facilitate printing of films and other shaped articles, particularly with water-based inks.

### Processability

Plasticizers wherein at least about 40 percent of the molecules are carboxylic acid terminated are self-lubricating, allowing a reduction in amount of transitory lubricants required in polymer compositions containing these plasticizers. The presence of both acid and alcohol terminal units provides the desirable combination of lubricity with high levels of surface energy. In this aspect, levels of lubricants may be reduced up to about 50% as compared to systems using known plasticizers. Known lubricants and stabilizers used to formulate flexible vinyl compositions include: stearic acid; calcium stearate; polyethylene wax; oxidized polyethylene waxes; montan wax esters; metal soaps (heat stabilizers such as barium stearate); acrylic process aides; organic heat stabilizers; paraffin oil; and amide waxes.

Other improvements in the processability of polymer compositions that can be achieved using the present polymeric plasticizers include but are not limited to 1) an increase in line speed of calandering (an increased temperature processing range for example up to about 345° F.) and extrusion and 2) increased plasticizer efficiency, allowing for a reduction in plasticizer concentration to achieve the same level of plastization.

The following non-limiting examples describe the preparation of preferred plasticizers and the unique combination of properties imparted by these plasticizers to a polymer composition and a film prepared from this compositions. Unless other wise specified all parts and percentages in the examples are by weight and property measurements were conducted at 23° C.

### EXAMPLE 1

This example describes the preparation of a polyester of this invention.

A 2000 mL-capacity resin kettle was equipped with a mechanical stirrer, heating means, a nitrogen inlet extending below the surface of the reaction mixture, a distillation column, and means for 1) recovering the water produced as a by-product of the esterification reaction and for 2) monitoring the temperatures of the reaction mass, refluxing liquid and vapor.

The reactor was charged with 329 grams (3.65 moles) of 1,3-butanediol, 457 grams

(3.13 moles) of adipic acid, 214 grams (0.83 mole) of palmitic acid and 0.21 grams

(0.00101 mol) of hydrated monobutyl tin oxide as the polymerization catalyst.

The contents of the reactor were heated to 120° C. to dissolve the solid reactants and the column was heated to a temperature of 90° C. Nitrogen was admitted into the reactor at a rate of approximately 70-100 mL/min and was maintained at this rate throughout the polyesterification reaction. When substantially all of the solid material had dissolved stirring of the reaction mixture was begun at a rate of 300 r.p.m. and the temperature of the reaction mixture was gradually increased to 210° C. over a five-hour period.

The amount of water removed as a by-product of the polyesterification reaction was monitored. During water removal the column temperature was slowly increased to 120° C. at a rate that was dependent upon the rate of water removal.

Five hours after heating of the reaction mixture was begun and at two-hour intervals thereafter samples of the reaction mixture were withdrawn using a syringe for determination of acid number. After 23 hours of heating the acid number had decreased to 6. At this time samples of the reaction mixture were withdrawn for determination of hydroxyl number and kinematic viscosity at 2-hour intervals.

Following a total of 32 hours of heating the polyesterification portion of the reaction was considered complete, at which time the nitrogen flow rate was increased to one liter per minute for about 7 hours. The acid number and kinematic viscosity of the reaction mixture were measured at one-hour intervals and the hydroxyl number was measured every 2 hours. At the end of this 7-hour period the reaction mixture was bleached using an aqueous solution of hydrogen peroxide and filtered. About 871 grams, equivalent to 87% yield, of a polyester was obtained. The polyester was a semi-solid at 25° C. and exhibited a kinematic viscosity of 78 centistokes at 210° F. (98.9° C.), an acid number of 0.8 mg. of KOH/gram of sample, a moisture content of 0.08 percent and an APHA color of 70.

The weight average molecular weight of the polyester, referred to hereinafter as polyester I, was about 3400 g./mole

Two commercially available polyester-type plasticizers were evaluated for comparative purposes. These will be referred to hereinafter as polyesters IIc and IIIc.

Polyester IIc was a commercially available polyester, Palamoll® 1654, manufactured by BASF Chemicals. This polyester exhibited a weight average molecular weight of 5200 g./mole and a hydroxyl number of 4 mg. KOH/gram.

Polyester IIIc was a commercially available polyester, Admex® 6985, manufactured by Velsicol Chemical Corporation. This polyester exhibited a weight average molecular weight of 7000 g./mole and a hydroxyl number greater that 15 mg. KOH/gram.

### EXAMPLE 2

This example demonstrates the improvements in processability and film properties of three polymer compositions containing three different plasticizers of this invention prepared as described in the preceding example. The properties are compared with those exhibited by a film prepared using the same polymer but with a plasticizer that is outside the scope of the present invention.

The films were prepared by blending 30, 40 or 50 parts by weight of the polyester to be evaluated example with 100 parts by weight of a suspension grade of polyvinyl chloride using a two-roll mill operating at a temperature of 320° F. (160° C.). The milling time was 8 minutes.

The resultant milled sheet was converted to a film exhibiting a thickness of from 0.003 to 0.004 inch (0.076 to 0.1 mm.) by pressing the milled sheet for 10 minutes under a pressure of 200 p.s.i. (14.06 kg./cm²).

The properties listed in Table 1 were evaluated using the following ASTM test methods:

### Surface Energy—ASTM D2578: Standard Test Method for Wetting Tension of Polyethylene and Polypropylene Films

Preparation of Milled Flexible PVC—ASTM method: D3596
Preparation of Compression Molded Plaques—ASTM method: D4703
Plasticizer Compatibility in PVC Compounds under Humid Conditions—ASTM method: D2383-69
Oven Heat Stability of PVC Compositions—ASTM method: D2115-92
Fusion of PVC Compounds Using a Torque Rheometer—ASTM method: D2538-95
Shore Hardness—ASTM method: D2240

TABLE 1

| | Polyester | | | | | | | | |
|---|---|---|---|---|---|---|---|---|---|
| | I | IIc | IIIc | I | IIc | IIIc | I | IIc | IIIc |
| PHR level of | 30 | 30 | 30 | 40 | 40 | 40 | 50 | 50 | 50 |
| plasticizer | | | | | | | | | |
| Dynamic Heat | 60 | 55 | 50 | 80 | 70 | 70 | 95 | 80 | 80 |
| Stability | | | | | | | | | |
| Minutes to | | | | | | | | | |
| Degradation | | | | | | | | | |
| Dynamic Heat | 1100 | 1150 | 1200 | 820 | 880 | 920 | 680 | 720 | 730 |
| Stability | | | | | | | | | |
| Break Point | | | | | | | | | |
| Torque Values | | | | | | | | | |
| Static Heat | 25 | 15 | 20 | 25 | 22 | 22 | 24 | 22 | 22 |
| Stability | | | | | | | | | |
| Inflection Point | | | | | | | | | |
| (minutes) | | | | | | | | | |
| First Yellow | | | | | | | | | |
| Static Heat | 45 | 30 | 30 | 35 | 35 | 35 | 45 | 30 | 35 |
| Stability | | | | | | | | | |
| Time to | | | | | | | | | |
| Degradation | | | | | | | | | |
| (minutes) | | | | | | | | | |
| First Brown | | | | | | | | | |
| Elongation, % | 150 (10) | 148 (16) | 113 (6) | 205 (3) | 195 (7) | 195 (7) | 228 (16) | 203 (6) | 202 (10) |
| after 2 days | | | | | | | | | |
| Cross Direction | | | | | | | | | |
| (std. deviation.) | | | | | | | | | |
| Tensile Strength, | 2814 (59) | 3044 (96) | 3013 (57) | 2902 (56) | 2665 (25) | 2655 (25) | 2477 (66) | 2388 (41) | 2511 (70) |
| psi after 2 days | | | | | | | | | |
| Cross Direction | | | | | | | | | |
| (std. deviation.) | | | | | | | | | |
| 100% Modulus, | 2645 (44) | 2879 (22) | 2979 (73) | 2379 (50) | 2195 (71) | 2195 (71) | 1783 (33) | 1705 (49) | 1867 (38) |
| psi after 2 days | | | | | | | | | |
| Cross Direction | | | | | | | | | |
| (std. deviation.) | | | | | | | | | |
| Shore A | 85 | 89 | 87 | 88 | 88 | 86 | 83 | 79 | 86 |
| Hardness, Instant | | | | | | | | | |
| Reading | | | | | | | | | |
| After 2 Days | | | | | | | | | |
| Shore Hardness, | 85 | 89 | 87 | 86 | 86 | 84 | 79 | 95 | 82 |
| 10 Second | | | | | | | | | |
| Reading | | | | | | | | | |
| After 2 Days | | | | | | | | | |
| Surface Energy, | 40 | 36 | 38 | 40 | 36 | 37 | 35 | 37 | 37 |
| (dynes) after 1 | | | | | | | | | |
| Hour Off 2-Roll | | | | | | | | | |
| Mill | | | | | | | | | |
| Surface Energy, | 39 | 37 | 38 | 38 | 37 | 38 | 39 | 37 | 38 |
| (dynes) after 1 | | | | | | | | | |
| Day Off 2-Roll | | | | | | | | | |
| Mill | | | | | | | | | |
| Surface Energy, | 38 | 37 | 37 | 37 | 36 | 36 | 37 | 36 | 36 |
| (dynes) After 1 | | | | | | | | | |
| Week Off 2-Roll | | | | | | | | | |
| Mill | | | | | | | | | |
| Surface Energy, | 39 | 38 | 39 | 40 | 38 | 38 | 39 | 39 | 39 |
| (dynes) on 3–4 | | | | | | | | | |
| Mil Pressed Film | | | | | | | | | |
| After 1 Day | | | | | | | | | |
| Surface Energy, | 39 | 39 | 39 | 39 | 38 | 38 | 36 | 38 | 38 |
| Dynes on 3–4 Mil | | | | | | | | | |
| Pressed Film after | | | | | | | | | |
| 1 Week | | | | | | | | | |
| Fusion Time on | 1:30 | 1:55 | 1:42 | 1:40 | 1:30 | 2:05 | 2:10 | 2:20 | 2:15 |
| 2-Roll Mill | | | | | | | | | |
| (minutes:seconds) | | | | | | | | | |
| Bagginess on 2- | 7 | 6 | 7 | 9 | 6 | 7 | 5 | 10 | 7 |
| Roll Mill | | | | | | | | | |
| Rating 10 = most, | | | | | | | | | |
| 1 = least | | | | | | | | | |
| Cleanliness on 2- | 6 | 6 | 8 | 7 | 8 | 7 | 4 | 6 | 4 |
| Roll Mill | | | | | | | | | |
| Rating 10 = most, | | | | | | | | | |
| 1 = least | | | | | | | | | |
| Picking on 2 Roll | 7 | 5 | 8 | 7 | 8 | 7 | 3 | 9 | 4 |
| Mill | | | | | | | | | |
| Rating 10 = most, | | | | | | | | | |
| 1 = least | | | | | | | | | |

TABLE 2

| Ingredients in Formulation | Concentration, phr | | | | | | | | |
|---|---|---|---|---|---|---|---|---|---|
| OxyVinyls 200F(PVC Resin) | 100 | 100 | 100 | 100 | 100 | 100 | 100 | 100 | 100 |
| Polyester I | 30 | — | — | 40 | — | — | 50 | — | — |
| Polyester IIc | — | 30 | — | — | 40 | — | — | 50 | — |
| Polyester IIIc | — | — | 30 | — | — | 40 | — | — | 50 |
| Atomite (Calcium Carbonate) | 15 | 15 | 15 | 15 | 15 | 15 | 15 | 15 | 15 |
| AC 629A (Oxidized Polyethylene) | 0.3 | 0.3 | 0.3 | 0.3 | 0.3 | 0.3 | 0.3 | 0.3 | 0.3 |
| ThermChek SP-175 (Heat Stabilizer) | 3 | 3 | 3 | 3 | 3 | 3 | 3 | 3 | 3 |
| TiPure R102 (TiO₂ Filler) | 10 | 10 | 10 | 10 | 10 | 10 | 10 | 10 | 10 |

That which is claimed is:

1. A polyester plasticizer having a weight average molecular weight of from 1,000 to 5,000 g./mol and comprising repeating units of the general formula —OR¹O(O)CR²C(O)—, wherein at least 96 percent of the terminal units of said polyester exhibit a general formula selected from the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radicals containing from 1 to 24 carbon atoms and phenyl, R⁴ is at least one member selected from the group consisting of alkyl radicals containing from 1 to 24 carbon atoms and tolyl and wherein the hydroxyl number of said polyester does not exceed 10 mg. KOH/gram.

2. A plasticizer according to claim 1 wherein R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—, R² is at least one member selected from the group consisting of alkylene containing from 4 to 6 carbon atoms and phenylene, R³ contains from 12 to 18 carbon atoms, and R⁴ is alkyl containing from 8 to 16 carbon atoms.

3. A plasticizer according to claim 2 wherein R¹ is alkyl containing 4 carbon atoms, R² contains 4 carbon atoms, and R³ contains 15 carbon atoms.

4. A plasticizer according to claim 1 wherein a portion of said terminal units are represented by each of said general formulae R³C(O)— and R⁴O—.

5. A plasticized polymer composition comprising
1) an organic polymer, and
2) polyester plasticizer having a weight average molecular weight of from 1,000 to 5,000 g./mol and comprising repeating units of the general formula —OR¹O(O)CR²C(O)—, wherein at least 96 percent of the terminal units of said polyester exhibit a general formula selected form the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radical containing from 1 to 24 carbon atoms and phenyl, R⁴ is at least one member selected from the group consisting of alkyl radicals containing from 1 to 24 carbon atoms and tolyl and wherein the hydroxyl number of said polyester does not exceed 10 mg. KOH/gram.

6. The plasticized polymer composition of claim 5 where said polymer is selected from the group consisting of homo- and copolymers of vinyl chloride, homo- and copolymers of acrylic and methacrylic acid and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and CH₂C(CH₃)₂CH₂—; R² is at least one member selected from the group consisting of alkylene containing from 4 to 6 carbon atoms and phenylene, R³ contains from 12 to 18 carbon atoms, R⁴ is alkyl containing from 8 to 16 carbon atoms, and from 10 to 50 parts by weight of said plasticizer are present per 100 parts by weight of said polymer.

7. A plasticized polymer composition of claim 6 wherein from 15 to 35 parts by weight of said plasticizer are present per 100 parts of said polymer, R¹ is alkyl containing 4 carbon atoms, R² contains 4 carbon atoms and R³ contains 15 carbon atoms.

8. A plasticized polymer composition of claim 5 wherein a portion of said terminal units are represented by each of said general formulae R³C(O)— and R⁴O—.

9. A calandered film formed from a plasticized polymer composition comprising
1) an organic polymer and
2) a polyester plasticizer having a weight average molecular weight of from 1,000 to 5,000, and comprising repeating units of the general formula —OR¹O(O)CR²C(O)—, wherein at least 96 percent of the terminal units of said plasticizer exhibit a general formula selected from the group consisting of R³C(O)— and R⁴O—, wherein R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radicals containing from 1 to 24 carbon atoms and phenyl, R⁴ is at least one member selected from the group consisting of alkyl radicals containing from 1 to 24 carbon atoms and tolyl, and wherein the hydroxyl number of said polyester does not exceed 10 mg. KOH/gram.

10. A film according to claim 9 having a surface energy greater than 34 dynes/cm. wherein said polymer is selected from the group consisting of homo- and copolymers of vinyl chloride, homo- and copolymers of acrylic and methacrylic acids and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—, R² is at least one member selected from the group consisting of alkylene containing from 4 to 6 carbon atoms and phenylene, R³ contains from 12 to 18 carbon atoms, R⁴ contains from 8 to 16 carbon atoms, and from 10 to 50 parts by weight of said plasticizer are present per 100 parts by weight of said polymer.

11. A film according to claim 10 wherein from 15 to 35 parts by weight of said plasticizer are present per 100 parts of said polymer, R¹ is alkyl containing 4 carbon atoms, R² contains 4 carbon atoms and R³ contains 15 carbon atoms.

12. A film according to claim 11 wherein a portion of said terminal units are represented by each of said general formulae R³C(O)— and R⁴O—.

13. A film according to claim 9 where said film is printable using a water-based ink and said from 15 to 35 parts by weight of said plasticizer are present per 100 parts by weight of said polymer.

14. A molded article formed from a polymer composition comprising
1) an organic polymer and
2) a polyester plasticizer having a weight average molecular weight of from 1,000 to 5,000, and comprising repeating units of the general formula —OR¹O(O)CR²C(O)—, wherein at least 96 percent of the terminal units of said plasticizer exhibit a general formula selected from the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radicals containing from 1 to 24 carbon atoms and phenyl, R⁴ is at least one member selected from the group consisting of alkyl radicals containing from 1 to 24 carbon atoms and tolyl, and the hydroxyl number of said polyester does not exceed 10 mg. KOH/gram.

15. A molded article according to claim 14 exhibiting a surface energy greater than 34 dynes/cm. wherein said polymer is selected from the group consisting of homo- and copolymers of vinyl chloride, homo- and copolymers of acrylic and methacrylic acid and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—, R² is at least one member selected from the group consisting of alkylene containing from 4 to 6 carbon atoms and phenylene, R³ contains from 12 to 18 carbon atoms, R⁴ is alkyl containing 16 carbon atoms and from 10 to 50 parts by weight of said plasticizer are present per 100 parts by weight of said organic polymer.

16. A molded article according to claim 15 wherein from 15 to 35 parts by weight of said plasticizer are present per 100 parts of said polymer, R¹ is alkyl containing 4 carbon atoms, R² contains 4 carbon atoms and R³ contains 15 carbon atoms.

17. A molded article according to claim 16 wherein a portion of said terminal units are represented by each of said general formulae R³C(O)— and R⁴O—.

18. An extruded profile formed from a polymer composition comprising
1) an organic polymer, and
2) a polyester plasticizer having a weight average molecular weight of from 1,000 to 5,000 and comprising repeating units of the general formula —OR¹O(O)CR²C(O)—, wherein at least 96 percent of the terminal units of said polyester exhibit a general formula selected from the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radicals containing from 1 to 24 carbon atoms or phenyl, and R⁴ is at least one member selected from the group consisting of alkyl radicals containing from 1 to 24 carbon atoms and phenylalkyl.

19. The profile of claim 18 exhibiting a surface energy greater than 34 dynes/cm. where said polymer is selected from the group consisting of homo- and copolymers of vinyl chloride, homo- and copolymers of acrylic and methacrylic acid and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—; R² is at least one member selected from the group consisting of alkylene containing from 4 to 6 carbon atoms and phenylene, R³ contains from 12 to 18 carbon atoms, R⁴ is alkyl containing from 8 to 16 carbon atoms, and from 10 to 50 parts by weight of said plasticizer are present per 100 parts by weight of said polymer.

20. A profile of claim 19 wherein said from 15 to 35 parts by weight of said plasticizer are present per 100 parts of said polymer, R¹ is alkyl containing 4 carbon atoms, R² contains 4 carbon atoms and R³ contains 15 carbon atoms.

21. A plasticized polymer composition according to claim 4 as a plastisol consisting essentially of an organic polymer and said polyester plasticizer.

22. A plasticized polymer composition according to claim 4 as an organosol consisting essentially of 100 parts by weight of a rigid organic polymer, from 15 to 50 parts by weight of said polyester plasticizer and from 5 to 70 parts of an organic liquid that is a non-solvent for said polymer.

23. A method of producing a plasticized polymer comprising blending an organic polymer and a polyester plasticizer, wherein the polyester plasticizer has a weight average molecular weight of from 1,000 to 5,000 g./mol and comprising repeating units of the general formula —OR¹O(O)CR²C(O)—, wherein at least 96 percent of the terminal units of said polyester exhibit a general formula selected from the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radical containing from 1 to 24 carbon atoms and phenyl, R⁴ is at least one member selected from the group consisting of alkyl radicals containing from 1 to 24 carbon atoms and tolyl and wherein the hydroxyl number of said polyester does not exceed 10 mg. KOH/gram.

24. The method of claim 23 wherein the polymer is selected from the group consisting of homo- and copolymers of vinyl chloride, homo- and copolymers of acrylic and methacrylic acid and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—; R² is at least one member selected from the group consisting of alkylene containing from 4 to 6 carbon atoms and phenylene, R³ contains from 12 to 18 carbon atoms, R⁴ is alkyl containing from 8 to 16 carbon atoms, and from 10 to 50 parts by weight of said plasticizer are present per 100 parts by weight of said polymer.

25. The method of claim 24 wherein from 15 to 35 parts by weight of said plasticizer are present per 100 parts of said polymer, R¹ is alkyl containing 4 carbon atoms, R² contains 4 carbon atoms and R³ contains 15 carbon atoms.

26. The method of claim 23 wherein a portion of said terminal units are represented by each of said general formulae R³C(O)— and R⁴O—.

27. A method of producing a calandered film comprising:
blending an organic polymer and a polyester plasticizer, wherein the polyester plasticizer has weight average molecular weight of from 1,000 to 5,000 g./mol and comprising repeating units of the general formula —OR¹O(O)CR²C(O)—, wherein at least 96 percent of the terminal units of said polyester exhibit a general formula selected from the group consisting of R³C(O)— and R⁴O—, R¹ is at least one member selected from the group consisting of linear and branched alkylene radicals containing from 3 to 6 carbon atoms, R² is at least one member selected from the group consisting of linear and branched alkylene radicals containing from 1 to 10 carbon atoms and phenylene, R³ is at least one member selected from the group consisting of linear and branched alkyl radical containing from 1 to 24 carbon atoms and phenyl, R⁴ is at least one member selected from the group consisting of alkyl radicals containing from 1 to 24 carbon atoms and tolyl and wherein the hydroxyl number of said polyester does not exceed 10 mg. KOH/gram.

28. The method of claim 27 wherein the film has surface energy greater than 34 dynes/cm. wherein said polymer is selected from the group consisting of homo- and copolymers of vinyl chloride, homo- and copolymers of acrylic and methacrylic acids and esters thereof, polyurethanes, epoxide polymers, and elastomers, R¹ is selected from the group consisting of —CH₂CH(CH₃)—, —CH₂CH₂CH(CH₃)—, —CH₂ CH(CH₃)CH₂—, —(CH₂)₄—, and —CH₂C(CH₃)₂CH₂—, R² is at least one member selected from the group consisting of alkylene containing from 4 to 6 carbon atoms and phenylene, R³ contains from 12 to 18 carbon atoms, R⁴ contains from 8 to 16 carbon atoms, and from 10 to 50 parts by weight of said plasticizer are present per 100 parts by weight of said polymer.

29. The method according to claim 28 wherein from 15 to 35 parts by weight of said plasticizer are present per 100 parts of said polymer, R¹ is alkyl containing 4 carbon atoms, R² contains 4 carbon atoms and R³ contains 15 carbon atoms.

30. The method according to claim 29 wherein a portion of said terminal units are represented by each of said general formulae R³C(O)— and R⁴O—.

31. The method according to claim 27 where said film is printable using a water-based ink and said from 15 to 35 parts by weight of said plasticizer are present per 100 parts by weight of said polymer.
